(19) United States
(12) Patent Application Publication
(10) Pub. No.: US 2021/0078888 A1
(43) Pub. Date: Mar. 18, 2021

(54) WASTEWATER TREATMENT APPARATUS AND METHOD

(71) Applicant: Ifeyinwa Rita KANU, Edinburgh (GB)

(72) Inventor: Ifeyinwa Rita KANU, Edinburgh (GB)

(21) Appl. No.: 17/048,441

(22) PCT Filed: Apr. 17, 2019
(86) PCT No.: PCT/GB2019/051093

§ 371 Date: Oct. 16, 2020

(30) Foreign Application Priority Data
Apr. 19, 2018 (GB) 1806382.6

(51) Int. Cl. C02F 9/00; B01D 1/26; B01D 53/02

(52) U.S. Cl. CPC C02F 9/00; C02F 1/048; B01D 53/025; B01D 1/26

(57) ABSTRACT

A method and apparatus for the treatment of wastewater. The method comprising receiving wastewater into a tank via a wastewater inlet, evaporating a fraction of the wastewater and thereby forming a concentrate, evaporating volatile organic compounds (VOCs) out of the wastewater, collecting the VOCs thereby evaporated, and processing the concentrate, said processing typically comprising anaerobic digestion and/or thermal hydrolysis of organic compounds contained within the concentrate.

### FIELD OF THE INVENTION

The invention relates to apparatus for treating wastewater and a method of use of the apparatus.

### BACKGROUND TO THE INVENTION

Wastewater treatment facilities commonly use the Activated Sludge (AS) process. AS is aerated sewage (and/or wastewater) that has been treated with aerobic microorganisms and in some cases facultative microorganisms. The sludge may then be treated through aerobic or anaerobic digestion.

The AS process is expensive and typically does not involve the recovery of any valuable materials alongside clean water (with the occasional exception of biogas when sludge is further treated using anaerobic digesters). Water treated via this process still contains contaminants and must be further treated by sand filtration, chlorination, ozonation, cascading and/or ultraviolet (UV) radiation before it can safely be returned to the water supply. The remaining solid matter also contains contaminants (e.g. surfactants and volatile organic compounds (VOCs)) that typically are not removed making it difficult to meet environmental standards (e.g. to obtain BSI PAS 100 (2011) certification) for most of the sludge resulting from this process.

Further, because in traditional wastewater treatment facilities the AS is processed using microorganisms that use aerobic biological processes to break down the organic matter within the AS, odorous compounds such as dimethyl disulphide and dimethyl trisulphide (largely produced in the presence of oxygen) are emitted. This occurs during the aerobic breakdown of biodegradable materials by microorganisms and from the oxidation of methanethiol (a natural substance found in animal and plant tissues and commonly present in wastewater treatment plants). In addition, as a result of the aerobic process utilised in AS, there is significant growth of microorganisms leading to a 3-fold increment in the total sludge flow that requires further treatment (usually in anaerobic digesters) compared to the initial wastewater flowing into the wastewater treatment plant. As a result of this, traditional wastewater facilities also have a large footprint and their size could be significantly reduced if such facilities did not need to use the AS system.

Hence, a further problem associated with the use of AS in wastewater treatment facilities is that these odorous compounds have a very high sulphur content and as a result, the biogas must be cleaned intensively so that it meets quality requirements before it can be used (e.g. in a cogenerator or before being supplied to the grid).

Anaerobic digestion refers to a collection of processes by which organic matter is broken down by microorganisms in the absence of oxygen. Anaerobic digestion involves the biochemical hydrolysis of organic polymers (such as carbohydrates and proteins) into small organic molecules, and the conversion of such small molecules into methane, carbon dioxide, nitrogen, and hydrogen, as well as other by-products. Typically, anaerobic digestion includes a hydrolysis stage, as well as acidogenesis, acetogenesis and methanogenesis and usually takes place within two temperature ranges; mesophilic digestion takes place between 20° C. and 45° C. and thermophilic digestion takes place between 49° C. and 70° C. The type of digestion and the temperature range are dependent on the species of microorganisms (e.g. methanogens) that are used.

Anaerobic digestion is used as part of a treatment process in the recycling of biodegradable waste such as food waste as well as sewage sludge and wastewater. This process typically results in the production of biogas (comprising around 50% to 80% methane), as well as liquid and solid digestate. Since biogas can be used as a fuel (for example, for a cogenerator), anaerobic digestion is considered a source of renewable energy. Biogas can be further refined to produce biomethane, which has a similar methane content to natural gas. The remaining digestate can be useful as a nutrient-rich fertiliser, as well as a source of higher-value chemical products.

Wastewater treatment facilities that use the AS system are therefore expensive, wasteful, energy intensive and have a large footprint. However, in the past, improvements to this system have been limited to improvement of wastewater facilities that continue to use AS, and new technologies are predominantly focused on improvements to either the quality or odour of the biogas, of the water, or of the remaining solid matter that is produced rather than on the development of an alternative approach to wastewater treatment.

For example, one alternative is the Nereda system which uses an optimised sequencing batch reactor cycle involving simultaneous influent feed and effluent discharge; simultaneous biological removal of organic nitrogen and phosphorous components using glycerol accumulating organisms and phosphorus accumulating organisms to achieve a faster settling phase, in which the biomass is separated from the effluent. However, this does not eliminate the challenge of increased sludge from the aerobic process or the production of odorous compounds. Nor does it involve significant recovery of the valuable substances present in wastewater.

Accordingly, the present invention seeks to address these problems with existing wastewater treatment facilities by providing a method of treating wastewater and an apparatus which do not involve the use of AS or of any aerobic process. Instead, wastewater is processed directly.

### SUMMARY OF THE INVENTION

A first aspect of the invention provides a method for treating wastewater, the method comprising receiving wastewater into a tank (e.g. an evaporation tank) via a wastewater inlet, (e.g. gradually) heating the received wastewater in the tank, thereby evaporating water and evaporating volatile organic compounds (VOCs) out of the wastewater and thereby forming a concentrate, the method further comprising collecting the evaporated VOCs (optionally using (e.g. preparative) gas chromatography) and processing the concentrate, said processing comprising anaerobic digestion (of biodegradable materials contained within the concentrate).

Typically, the method comprises heating of the wastewater. Typically, the method comprises heating of the concentrate. Typically, the method comprises two-stage anaerobic digestion, the two-stage anaerobic digestion comprising a first anaerobic digestion stage, the first anaerobic digestion stage comprising anaerobic digestion of the concentrate and thereby forming a sludge, and a second anaerobic digestion stage, the second anaerobic digestion stage comprising anaerobic digestion of the sludge. Typically, the first digestion stage takes place in a first digestion chamber and the second digestion stage takes place in a second digestion chamber (e.g. at least partially) separated from the first digestion chamber. Typically, the method further comprises heating and/or thermal hydrolysis of the wastewater and/or of the concentrate, typically of the (e.g. microbially hydrolysed) sludge. Typically, the thermal hydrolysis (e.g. of organic matter) takes place after the first anaerobic digestion stage and before the second anaerobic digestion stage. Typically, the thermal hydrolysis takes place in a thermal hydrolysis chamber (e.g. at least partially) separated from the first and/or second digestion chambers.

Alternatively, the method may comprise single-stage anaerobic digestion of the concentrate and thermal hydrolysis of the concentrate, in which case the single-stage anaerobic digestion of the concentrate takes place after the thermal hydrolysis of the concentrate. For example, a method comprising single-stage anaerobic digestion may be more suitable for smaller wastewater treatment facilities. In each case we refer to the order of steps carried out on specific organic matter (e.g. a specific quantity of organic matter, for example in a specific quantity of wastewater). Multiple stages may be carried out concurrently on different aliquots of organic matter.

Typically, the evaporation comprises vacuum evaporation. Typically, the vacuum evaporation comprises generating water vapour. Optionally, water evaporated (i.e. water vapour) during vacuum evaporation is subsequently condensed, optionally by causing heat exchange from the water vapour to subsequent influent batches of wastewater received into the (e.g. evaporation) tank (e.g. by either directly causing it to return to the evaporation tank and/or through the use of one or more heat exchangers). Optionally, the water vapour is compressed and/or recycled into the system to aid with (e.g. at least in part) subsequent heating of (e.g. the contents of) the evaporation tank and/or (e.g. the contents of) the (e.g. single-stage and/or two-stage) anaerobic digester, for example through the use of one or more heat exchangers. Optionally, this process may cool (and in some cases condense) the water vapour. Optionally, the water vapour may be recycled into the system multiple times.

Typically, where a two-stage anaerobic digester is used, the two stage anaerobic digester comprises a first digestion chamber and a second digestion chamber (e.g. at least partially) separated from the first digestion chamber. Optionally, the two-stage anaerobic digester may further comprise a thermal hydrolysis chamber, optionally (e.g. at least partially) separated from the first digestion chamber and/or from the second digestion chamber.

Typically, vacuum evaporation does not begin until the tank (e.g. the evaporation tank) contains a predetermined minimum volume of wastewater. Typically, the vacuum evaporation comprises reducing the pressure within the tank (e.g. the evaporation tank) to below atmospheric pressure (e.g. to low vacuum). Typically, the vacuum evaporation comprises reducing the pressure within the tank to below 50 kPa, or preferably to below 30 kPa. Typically the vacuum evaporation comprises reducing the pressure within the tank to 20 kPa±5 kPa. Typically, vacuum evaporation comprises the use of a vacuum pump in order to reduce the pressure within the tank (e.g. the evaporation tank). The vacuum pump is connected to the interior of the tank (e.g. the evaporation tank), optionally through one or more valves.

Reducing the pressure within the tank (e.g. the evaporation tank) has the result that both water and VOCs within the wastewater will evaporate more readily and at a lower temperature. This has the advantage that less energy is required to heat the tank (e.g. the contents of the tank) in order to cause the water and/or the VOCs within the wastewater to begin to evaporate. For example, at 20 kPa, water evaporates at ˜59° C., rather than at ˜100° C. (the temperature at which it evaporates at atmospheric pressure).

Typically, reducing the pressure causes the VOCs to begin to evaporate from the wastewater and these can be removed from the tank (e.g. the evaporation tank). Typically, the method further comprises heating the tank (e.g. by turning on the one or more heating means (e.g. heaters)) to thereby cause the temperature within the tank (e.g. the contents of the tank) to (e.g. gradually) increase to at least 50° C. or preferably to at least 60° C. Typically, the heating comprises causing the temperature of the tank (e.g. the contents of the tank) to increase to 60° C.±5° C. At ˜60° C. water begins to evaporate thereby forming water vapour. The heating means are in thermal communication, whether directly or indirectly, with the tank (e.g. the evaporation tank).

Typically, the vacuum evaporation comprises maintaining the conditions, including the pressure (e.g. ˜20 kPa) and the temperature (e.g. ˜60° C.), within the tank substantially constant for at least 1 hour, or preferably for a period of time in excess of 1 hour. Preferably, the conditions, including the pressure (e.g. ˜20 kPa) and the temperature (e.g. ˜60° C.), within the tank are substantially maintained until sufficient water has evaporated that a concentrate of the remaining wastewater is created. Typically, the concentrate comprises at least 8% by weight dry solids, or more preferably at least 10% by weight dry solids. Preferably, the concentrate will not comprise more than 15% by weight dry solids. Typically, the method comprises causing the said concentrate to undergo anaerobic digestion.

Typically, the anaerobic digestion comprises the production of biogas (e.g. methane (CH₄) typically at least 50% of the biogas comprising (e.g. being) methane, or preferably at least 60% of the biogas comprising (e.g. being) methane, or more preferably at least 70% of the biogas comprising (e.g. being) methane) and/or collection of the biogas. Optionally, the method further comprises combustion of the biogas, for example in a cogenerator (e.g. a combined heat and power (CHP) generator) and thereby generating energy. Optionally, the energy generated by combusting the biogas (e.g. in the cogenerator) may be used to power the method. Optionally, the energy generated by combusting the biogas (e.g. in the cogenerator) may be supplied to the grid.

Although the anaerobic digestion may be single-stage anaerobic digestion, typically, the anaerobic digestion is two-stage anaerobic digestion, the two-stage anaerobic digestion comprising a first stage and a second stage. Typically, the first stage comprises (e.g. microbial) hydrolysis of the concentrate and/or acidogenesis and/or acetogenesis. Optionally, the first stage may further comprise thermal hydrolysis. Optionally, there may be a thermal hydrolysis step (e.g. carried out on organic matter) after the first stage and before the second stage and the method may comprise carrying out the thermal hydrolysis step after the first stage and before the second stage. Typically, the second stage comprises methanogenesis. Methanogenesis causes the production of biogas, the biogas comprising methane. In embodiments wherein the anaerobic digestion is a one-stage anaerobic digestion the microbial hydrolysis of the concentrate, acidogenesis, acetogenesis, thermal hydrolysis and/or methanogenesis may all take place in a single stage.

Typically, the method comprises causing the process of acidogenesis (e.g. during the first stage of the two-stage anaerobic digestion) to occur for at least 1 hour, or more preferably 2 hours.

Typically, the method comprises controlling the temperature of the anaerobic digester (e.g. the second digestion chamber of the anaerobic digester and/or the contents of the second chamber of the anaerobic digester) such that the temperature is at least 30° C., or more preferably at least 35° C. (e.g. 35° C.±3° C., or more preferably 35° C.±0.5° C.).

In some embodiments, the method is carried out in a semi-continuous batch process such that the treatment phase in one tank may be the same or different to the treatment phase in the or each other tank at any given time. In some embodiments, the method is carried out in a batch process. In some embodiments, the method is carried out continuously. Typically, more than one of the tanks is used to treat wastewater simultaneously.

The invention is suitable for treating wastewater. The wastewater may include greywater (e.g. water from sinks, showers, dishwashers etc.) and optionally blackwater and/or dissolved or suspended compounds including soaps, detergents and/or solids.

Typically, the method further comprises causing the VOCs to be captured by a gas collector (e.g. a gas recovery system) and/or supplied to a gas separator. The gas collector is typically in gaseous communication with the interior of the (e.g. evaporation) tank, typically through one or more valves. Typically, the gas separator comprises a (e.g. preparative) gas chromatograph (GC) and the VOCs are optionally thereby separated into distinct, individual compounds.

Typically, receiving the wastewater comprises regulating the flow of received water. Typically, receiving the wastewater comprises a flow measurement step, a comminution step and/or a filtration step. Processing the wastewater may further comprise one or more additional processing steps.

Optionally, thermal hydrolysis may take place in the evaporation tank. Optionally, thermal hydrolysis may take place in a thermal hydrolysis chamber.

A second aspect of the invention provides an apparatus for treating wastewater, the apparatus comprising a wastewater inlet (through which wastewater is introduced in use), a controller, a gas collector, an anaerobic digester, at least one heating means (e.g. one or more heaters and/or one or more heat exchangers) at least one tank (e.g. a vacuum evaporation tank), and at least one vacuum pump, the at least one tank comprising at least one tank inlet (through which (e.g. filtered) wastewater may be introduced) and at least one tank outlet, wherein the heating means and/or the vacuum pump are configured to cause (e.g. vacuum) evaporation of the contents of the tank, and to thereby form water vapour, a concentrate and, if present, evaporated volatile organic compounds (VOCs). The gas collector may be configured to collect volatile organic compounds, where present, thereby evaporated from the contents of the tank.

The apparatus may be configured to cause the concentrate to be conveyed to the anaerobic digester (for example, using a pump). The anaerobic digester typically comprises one or more digestion chambers for retaining wastewater (e.g. concentrated wastewater, optionally centrifuged, filtered and/or otherwise treated wastewater) and/or organic matter (e.g. wastewater contaminants) and/or sludge (e.g. comprising partially digested organic matter and anaerobic microorganisms).

The use of such an apparatus is an improvement over the use of traditional wastewater facilities (i.e. facilities utilising the Activated Sludge (AS) process) for several reasons. Firstly, because there is no need to use AS in order to treat the wastewater, the wastewater can be supplied directly to the apparatus. This reduces the volume load of sludge needing further treatment on the facility (in facilities utilising AS the total volume of AS including water is typically approximately three times the volume of the wastewater flowing into the facility). By treating only this smaller initial volume, the process can be more energy efficient and potentially may be carried out more quickly.

The apparatus may be operated according to the method of the first embodiment. The controller (which typically comprises a hardware processor and memory in electronic communication with the processor, the memory storing a computer program (e.g. computer code) executed by the hardware processor in use) may be configured to control the apparatus according to the first embodiment of the invention.

Secondly, the use of heating means and a vacuum pump alongside a gas collector allows the removal of VOCs from the wastewater, a step that is not carried out in the operation of traditional wastewater facilities. Removing the VOCs from the wastewater means that VOCs will not be present in the concentrate that is supplied to the anaerobic digester and, in turn, will not be present in the digestate that is produced by the anaerobic digester. It has been found, surprisingly, that the said digestate meets environmental standards including the British Standards Institution's (BSI) Publicly Available Specification (PAS) 100 rating (as updated in 2011), which provides a quality specification for compost materials. The digestate is therefore suitable for use as a fertiliser, for example. Substances passing the PAS 100 may be considered “products” as opposed to “wastes.”

Thirdly, the VOCs represent a valuable resource, in that they are useful in a wide range of industries. Because this apparatus allows the VOCs to be collected and optionally separated into distinct, individual compounds, this valuable resource is not wasted, or deliberately consumed, as it is in traditional wastewater treatment facilities. VOCs may comprise, for example, aromatic hydrocarbons, halogenated hydrocarbons, alcohols, ketones, etc.

Further, because both the concentrate and the resulting digestate have been sanitised through the removal of VOCs, the digestate may be cleaner than the solid matter produced by traditional wastewater treatment facilities. In addition, because the concentrate is digested by anaerobic microorganisms in an oxygen-free environment, the digestate produced contains fewer odorous compounds (e.g. dimethyl disulphide or dimethyl trisulphide) and therefore is not as odorous as the solid (or sludge) matter produced by traditional wastewater treatment facilities.

In some embodiments the gas collector comprises a gas recovery system.

In some embodiments the apparatus further comprises a generator, for example a cogenerator (e.g. a combined heat and power (CHP) generator) configured to combust biogas, for example biogas generated by the anaerobic digester. Typically, the biogas is temporarily stored in a gas (e.g. biogas) collection chamber before being combusted in the cogenerator. Optionally, the method may comprise recovering heat generated by the cogenerator and/or using the recovered heat in heating of the system, thus improving energy efficiency. Alternatively or additionally, the water vapour recovered by vacuum evaporation may be recycled into the system to also aid heating of the system, thus improving energy efficiency.

In some embodiments the gas collector (e.g. a gas recovery system) comprises a gas chromatograph (GC) (typically a large scale preparative GC), the GC comprising a column, a detector (e.g. an online sensor in communication with the controller, optionally a thermal conductivity detector), a plurality of valves (e.g. for selectively trapping distinct, individual compounds), a plurality of condensers, a plurality of gas-liquid separators, and/or a plurality of VOC collection containers, and a gas injector, the gas collector optionally further comprising a heating means. Typically, the gas collector (e.g. the gas recovery system) further comprises a pump (for example to remove small quantities of less commonly occurring VOCs which may optionally lead to one or more further collection containers, in which case said less commonly occurring VOCs may undergo further fractioning offsite), one or more carrier gas cleaners, one or more carrier gas compressors and/or one or more carrier gas (e.g. pre-) heaters.

Typically, the method comprises causing the VOCs to be captured by the gas collector and/or supplied to a GC (typically a large scale preparative GC) and thereby separated into distinct, individual compounds. Typically, the method comprises directing distinct, individual compounds (or categories of compounds) to individual VOC collection containers. Typically, directing distinct, individual compounds (or categories of compounds) to individual VOC collection containers comprises the controller receiving a signal from the detector indicating which of several possible distinct, individual compounds (or categories of compounds) is eluting from the column of the GC and the controller operating one or more valves such that the said individual compounds (or categories of compound) collect in an appropriate collection container. Typically, the method comprises causing the VOCs to be condensed in the VOC collection containers.

In some embodiments the apparatus comprises a conduit through which wastewater and/or concentrate (e.g. concentrate) may flow into the anaerobic digester.

Typically, the wastewater inlet comprises a pipe and one or more sieves and/or one or more filters suitable for the removal of any pieces of solid matter (e.g. grit and/or pieces of fabric) greater than a threshold size from the wastewater before the wastewater enters one or more of the plurality of tanks (e.g. evaporation tanks). The wastewater inlet may branch into a plurality of tank inlets, thus serving as a fluid flow path from the wastewater inlet to one or each of the plurality of tanks.

In some embodiments the wastewater inlet further comprises one or more valves. The wastewater inlet may be (i.e. at least partially) sealable. The wastewater inlet may comprise a watertight, or optionally an airtight, seal. The inlet of the or each tank inlet typically comprises a pipe. In some embodiments, the or each tank inlet further comprises one or more valves. The or each tank inlet may be (i.e. at least partially) sealable. The or each tank inlet may comprise a watertight, or optionally an airtight, seal. The or each tank outlet typically comprises a pipe. In some embodiments the or each tank outlet further comprises one or more valves. The or each tank outlet may be (i.e. at least partially) sealable. The or each tank outlet may comprise a watertight, or optionally an airtight, seal. Preferably, the apparatus is airtight (except for the wastewater inlet and the outlets).

In some embodiments, the apparatus may further comprise flow regulation means (e.g. a wastewater flow regulator and/or a concentrate flow regulator) for regulating the flow of wastewater (optionally concentrated wastewater (concentrate) and/or filtered wastewater and/or otherwise treated wastewater) and/or the flow of (e.g. thermally hydrolysed) sludge and/or digestate through the apparatus. The flow regulation means may comprise (e.g. consist of) a pump. The method may comprise regulating the flow of received wastewater.

Typically, the at least one tank inlet is a filtered wastewater inlet. Typically, the plurality of outlets comprise at least one VOC outlet, at least one water vapour outlet and/or at least one concentrate outlet (i.e. an outlet through which concentrated wastewater (concentrate) may flow). Typically, the plurality of outlets comprises fluid outlets (e.g. gas outlets and/or liquid outlets).

Typically, the at least one VOC outlet leads from at least one of the or each tank to the gas collector (e.g. a gas recovery system) and/or to at least one VOC collection container, optionally via the GC. The or each VOC collection container is typically large enough to contain at least 10 L of a given VOC, or preferably at least 50 L of a given VOC, or more preferably at least 100 L of a given VOC. Typically, the at least one water vapour outlet leads to a water vapour condensation container. The water vapour condensation container may have a capacity of at least 700 L, or more preferably at least 1,000 L. (By a litre of water we refer to the volume of the (liquid) water at standard pressure and by a litre of gas we refer to the volume of the gas at standard pressure and temperature, irrespective of the temperature and pressure at which it is stored in the gas storage chamber.)

Typically, the vacuum evaporation comprises causing the or each heating means (e.g. the or each heater) to be switched on, such that the temperature in the or each tank is (e.g. gradually) increased. The method further comprises causing the or each vacuum pump to be switched on to thereby (e.g. gradually) evacuate the or each tank, thereby causing the pressure in the or each tank to be (e.g. gradually) decreased. This causes volatile organic compounds (VOCs) to separate out individually from the supplied wastewater. Due to the reduced pressure in the or each tank, the VOCs separate out from the wastewater at a lower temperature than they would at atmospheric pressure.

Because vacuum pumps are used, the pressure inside the or each tank is reduced. The boiling temperature of the water (and VOCs) is therefore correspondingly reduced. As a result, less energy is required to separate water vapour (and/or VOCs) from wastewater introduced into the system (and therefore the method is correspondingly energy efficient).

When the temperature within the or each tank reaches ˜60° C., water vapour begins to form. The method may comprise causing the water vapour to leave the said tanks via a tank outlet (e.g. a gas outlet, optionally a water vapour outlet) and to collect in a condenser. The method may further comprise causing the condensed water to be returned to the mains water supply or river.

Optionally, the method may comprise compressing the collected water vapour, thereby causing the temperature of the water to increase, and subsequently recycling the water as a heat source for other steps in the method (e.g. thermal hydrolysis, for example via steam explosion) and/or for increasing the temperature of incoming wastewater (for example, in a different tank where multiple tanks (e.g. evaporation tanks) are provided). Optionally, the increase of the temperature of incoming wastewater through the use of compressed (and thereby heated) water vapour may comprise the use of a heat exchanger. Optionally, where the water vapour is recycled for further use in the method, via one or more heat exchangers, the water vapour may be recycled repeatedly (e.g. for thermal hydrolysis and/or for drying of the digestate).

As water vapour leaves the or each tank, the remaining contents of the or each tank are concentrated, thereby creating a concentrate. Typically, when the said concentrate reaches a predetermined threshold dry-solid percentage (for example, 8%, or 10% by weight) the method comprises transferring the concentrate to a first digestion chamber of the two-stage anaerobic digester to thereby cause the first stage of the two-stage anaerobic digestion process to begin.

Typically, the first stage of the anaerobic digestion process comprises thermophilic microbial hydrolysis of the concentrate and/or acidogenesis and/or acetogenesis. Typically, the thermophilic microbial hydrolysis takes place at a temperature between 60° C. and 80° C., or preferably between 65° C. and 75° C. (e.g. at 70° C.). Typically, the thermophilic microbial hydrolysis takes place within 4 hours, or preferably within 3 hours, or more preferably within 2 hours (e.g. typically within 2 hours) of the concentrate being supplied to the first digestion chamber of the two-stage anaerobic digester. Typically, the first stage of anaerobic digestion results in the production of a sludge. Typically, the method comprises causing the sludge (and/or concentrate) to move from the first digestion chamber of the two-stage anaerobic digester to the thermal hydrolysis chamber, optionally to the second digestion chamber. Optionally, the method comprises causing the sludge (and/or concentrate) to move from the first digestion chamber to the second digestion chamber via the thermal hydrolysis chamber.

Typically, the method further comprises increasing the temperature in the thermal hydrolysis chamber. Typically, the temperature in the thermal hydrolysis chamber is further increased to 140° C., or more preferably 150° C., or more preferably 160° C. Typically, the method comprises causing the temperature in the tank to be increased to between 150° C. and 165° C. (e.g. 160° C.+/−1° C.). Optionally, the increase in temperature is caused by steam explosion. This temperature increase causes a corresponding pressure increase and causes thermal hydrolysis, leading to the production of a thermally hydrolysed (and typically pasteurised) sludge.

Optionally, the method further comprises an additional VOC recovery stage subsequent to the thermal hydrolysis, allowing the collection of remaining VOCs generated during thermal hydrolysis and/or during (e.g. the first stage of) anaerobic digestion.

The thermal hydrolysis has been found to improve biodegradability and viscosity of the digestate (e.g. by enhancing cellular breakdown and improving the availability of nutrients for subsequent uptake by, for example, methanogenic archaea). This has the result of increasing the production of biogas (as is known in the art).

Typically, the method further comprises causing the sludge to leave the or each first anaerobic digestion chamber and/or the or each thermal hydrolysis tank via the conduit and to thereby enter the second digestion chamber of the two-stage anaerobic digester. Typically, this causes the second stage of the two-stage anaerobic digestion phase to commence. Typically, the second stage of the two-stage anaerobic digestion comprises methanogenesis (e.g. methanogenic conversion of the sludge leading to the generation of biogas, the biogas comprising methane). Typically, the second stage of the two-stage anaerobic digestion takes place between 30° C. and 40° C., preferably between 32° C. and 38° C. (e.g. at 35° C.±1° C.).

The use of a two-stage anaerobic digestion process, in which the first and second anaerobic digestion stages are separated by a thermal hydrolysis step, provides the advantage of increasing the efficiency of the process. The two-stage process comprising thermal hydrolysis enables selective growth of desired microbial populations in two distinct anaerobic stages which in turn enables effective intelligent control of operating conditions (e.g. nutrient quality and/or quantity of the concentrate and/or of the sludge, temperature, pH, etc.) using measurements provided by the one or more sensors. In this way the process may be optimised. The advantageous result of this is improved degradation of biodegradable substances within the wastewater when compared to that achieved by traditional wastewater treatment facilities, as well as a correspondingly higher yield of biogas, said biogas comprising a higher percentage of methane and therefore having a greater calorific value and requiring less purification.

Typically, the anaerobic digester is a two-stage anaerobic digester. Typically, the two-stage anaerobic digester comprises a first digestion chamber and second digestion chamber at least partially separated from the first digestion chamber. Optionally, the two-stage anaerobic digester comprises a first digestion chamber, a thermal hydrolysis chamber (e.g. partially separated from the first digestion chamber) and a second digestion chamber at least partially separated from the first digestion chamber and/or from the thermal hydrolysis chamber.

The apparatus typically further comprises a plurality of sensors. The or each sensor may comprise one or more pH sensors, flow meters, temperature sensors (e.g. thermometers), pressure sensors (e.g. barometers), thermal conductivity sensors, weight sensors (e.g. scales), volume sensors, and/or gas sensors (e.g. nitrogen, oxygen, methane, etc.) sensors. The or each sensor may be configured to monitor conditions in the or each tank and/or in the or each anaerobic digester. In embodiments wherein one or more sensors are configured to monitor conditions in the or each digester, the one or more sensors may be configured to monitor one or more anaerobic digestion process parameters.

The method typically comprises separating evaporated VOCs using a gas chromatograph (GC). Typically, the (GC) comprises a large scale preparative GC. Typically, the GC comprises a GC-inlet, a GC-outlet and a column, the column comprising a stationary phase (e.g. siloxane, a polyethylene glycol, or a suitable porous polymer such as 2,6-diphenyl-para-phenylene oxide) and a carrier gas (e.g. hydrogen or helium). In a large scale preparative GC, the carrier gas flows continuously through the column, the column being packed with the said stationary phase. Typically, the GC is configured to allow a mixture to be introduced (e.g. by gas injection) into the carrier gas at the GC-inlet. The various individual components of the mixture are eluted at the GC-outlet at different times, according to their relative volatilities and their affinities for the stationary phase. This allows the collection of purified VOCs; the purified VOCs can then be used elsewhere.

Optionally, the introduction of the mixture into the carrier gas comprises as great a volume of the mixture as is practicable (e.g. 2 kg of mixture per injection into a GC column with a diameter of 500 mm and up to 4 injections per hour). Optionally, the introduction of the mixture comprises as small a volume of the mixture as is practicable. The greater the volume of mixture introduced into the column, the more inefficient the separation of the VOCs. This can be improved by increasing the column length, as is known in the art. Typically, the GC-outlet leads to VOC collection containers.

Typically, the conduit connects the tank with the (e.g. two-stage) anaerobic digester. Typically, the conduit is a pipe or a tube. In embodiments wherein the anaerobic digester is a two-stage anaerobic digester, the first stage of the two-stage anaerobic digester is typically an initial stage in which hydrolysis and/or acidogenesis and/or acetogenesis takes place. Typically, the first stage takes place in the first digestion chamber. Typically, the second stage of the two-stage anaerobic digester is a subsequent stage in which methanogenesis takes place. Typically, the second stage takes place in the second digestion chamber.

Anaerobic digestion is the process by which organic matter is broken down by microorganisms in the absence of oxygen. Microorganisms responsible for anaerobic digestion typically include anaerobic bacteria and/or anaerobic archaea. Anaerobic digestion typically includes one or more of the following processes: hydrolysis of large molecules (e.g. polymers such as carbohydrates (e.g. polysaccharides) and/or proteins (e.g. polypeptides) and/or lipids (e.g. triglycerides)) to form smaller molecules (e.g. simple sugars, amino acids and/or fatty acids); acidogenesis of the products of hydrolysis to form, for example, volatile fatty acids (VFAs); acetogenesis of the products of hydrolysis and/or acidogenesis to form acetic acid (as well as propionic acid, butyric acid, etc.); and methanogenesis of the products of hydrolysis, acidogenesis and/or acetogenesis to form methane (CH₄). The method of using controlled anaerobic digestion of organic matter to produce biogas including methane is known in the art. Typically, biogas contains at least 50% methane.

The first and second digestion chambers (and optionally the thermal hydrolysis chamber) may be located (e.g. horizontally) adjacent to one another. The first and second digestion chambers may be connected by a digestion chamber conduit. The digestion chamber conduit may extend substantially (e.g. horizontally) between the said first and second digestion chambers. Alternatively, the first digestion chamber may be connected via a conduit to the thermal hydrolysis chamber, which may in turn be connected via a conduit to the second digestion chamber.

It has been found that by separating (i.e. spatially) the process of methanogenesis from that of hydrolysis, acidogenesis and/or acetogenesis, more complete digestion of the organic matter (i.e. organic matter contained within the wastewater) is possible. This is because key process parameters, such as VFA concentration (VFAs being produced during hydrolysis, acidogenesis and/or acetogenesis), nitrogen concentration and pH, to which methanogenic microorganisms are particularly sensitive, can be more accurately controlled in the region in which methanogenesis occurs by regulating the flow of sludge between the first anaerobic digestion chamber (and/or thermal hydrolysis chamber) and second digestion chambers (where the first and second anaerobic digestion chambers correspond to the first and second phases of anaerobic digestion, respectively) of the two-stage anaerobic digester. Hence, the process parameters can optionally be optimised to maximise methane output and minimise system perturbations. Accordingly, both the first and the second digestion chambers of the two-stage anaerobic digester are chambers in which anaerobic digestion take place in use.

In embodiments wherein one or more sensors are provided within the or each two-stage anaerobic digesters, the one or more sensors may be configured to measure a parameter indicative of the volume of material (e.g. organic matter and/or wastewater comprising organic matter and/or concentrate comprising organic matter) in the first digestion chamber and/or in the thermal hydrolysis chamber and/or in the second digestion chamber. In embodiments wherein one or more sensors are provided within the or each two-stage anaerobic digesters, the one or more sensors may be configured to measure a parameter indicative of the quantity of sludge (e.g. organic matter and/or wastewater comprising organic matter and/or concentrate comprising organic matter) and/or the quality of sludge (e.g. by measuring the presence of various compounds and/or nutrients) in the first digestion chamber and/or in the thermal hydrolysis chamber and/or in the second digestion chamber.

The apparatus may be configured to regulate the temperature of (e.g. the contents of) the or each tank and/or the or each first and second digestion chambers and/or thermal hydrolysis chamber. Typically, the temperature is regulated through use of the one or more heating means (e.g. heaters). Typically, the temperature of the (e.g. the contents of the) or each tank and/or the or each first and second digestion chamber and/or thermal hydrolysis chamber temperature is regulated, for example, to be higher than the ambient temperature (i.e. the temperature of the surrounding environment). In some embodiments the heating means may be a solar concentrator and/or an optical heating means comprising one or more lenses. In some embodiments the heating means comprises one or more heat exchangers.

Typically, the two-stage anaerobic digester further comprises at least one biogas-outlet configured to allow biogas (e.g. methane or a mixture of gases comprising methane) to leave the digester. The apparatus may comprise at least one gas storage chamber (e.g. a gas accumulator). The biogas-outlet may lead to the at least one gas storage chamber.

Typically, the digestion phase of the method comprises anaerobic digestion of the concentrate by microorganisms, resulting in the production of biogas. The method may comprise collection of the biogas. The method may comprise energy production in which the biogas and/or the hydrolysed concentrate are used as a fuel (e.g. by combustion in the generator). Optionally, the method may comprise using the energy produced by the said energy production to power the apparatus and/or the method. The gas storage chamber is typically configured (e.g. sized) to store at least 100 L, 200 L, 500 L, 1,000 L, 5,000 L or more typically at least 10,000 L of gas (e.g. for large scale wastewater treatment plants). (By a litre of gas we refer to the volume of the gas at standard pressure and temperature, irrespective of the temperature and pressure at which it is stored in the gas storage chamber).

In some embodiments, the apparatus further comprises one or more gas purifiers. The or each gas purifier may comprise one or more gas filters. The one or more gas filters may be configured to (e.g. selectively) remove one or more (i.e. gaseous) species from the gases produced during anaerobic digestion of organic matter in the first and/or second chambers and/or the thermal hydrolysis chamber of the two-stage anaerobic digester. The one or more gas filters may be configured to (e.g. selectively) remove one or more of the following species: carbon dioxide (CO₂), hydrogen sulphide (H₂S), ammonia (NH₃). The one or more gas filters may comprise carbon (e.g. activated carbon, charcoal). The one or more gas filters may comprise potassium permanganate.

In embodiments wherein the apparatus comprises a generator (e.g. a cogenerator), the generator (e.g. the cogenerator) is typically configured to receive a flow of gas (e.g. biogas, typically predominantly methane gas) from the or each first and/or second digestion chambers and/or the thermal hydrolysis chamber and/or from the gas storage chamber and/or the or each gas purifier. The generator (e.g. the cogenerator) may be configured to combust the gas received. The generator may be configured to output electricity and/or heat generated by combustion of the gas.

In some embodiments, the apparatus may further comprise means for agitating the wastewater within the or each tank. In some embodiments, the apparatus may further comprise means for agitating the concentrate and/or digestate in the first and/or the second chamber and/or the thermal hydrolysis chamber of the two-stage anaerobic digester. For example, the apparatus may comprise one or more paddles provided within the tank and/or the first chamber of the two-stage anaerobic digester and/or the thermal hydrolysis chamber and/or the second chamber of the two-stage anaerobic digester. The one or more paddles may be movable (e.g. rotatable) such that movement (e.g. rotation) of the one or more paddles causes agitation (e.g. mixing) of the contents of the tank and/or the first chamber of the two-stage anaerobic digester and/or the thermal hydrolysis chamber and/or the second chamber of the two-stage anaerobic digester (depending on where within the apparatus the paddle is provided).

The controller may be configured to receive measurements of one or more parameters from the one or more sensor. The controller may be configured to cause a change in the operation of the apparatus responsive to the received measurements. For example, the controller may be configured to receive measurements of the temperature of the (e.g. the contents of) the or each tank and to regulate the operation of the means for heating the or each tank responsive to the received temperature measurement. The controller may be a programmable logic controller (PLC). The controller may comprise a processor (e.g. a microprocessor).

The apparatus may further comprise a signal transmitter and/or a signal receiver. For example, the apparatus may comprise a wireless network transmitter and/or receiver, or a Bluetooth transmitter and/or receiver. The controller may be configured (e.g. programmed) to communicate with a remote device (such as a personal computer, tablet computer and/or mobile telephone) using the transmitter and/or receiver.

The controller may be programmed to send and receive signals to and from the remote device in response to one or more outputs from the one or more sensors. For example, the controller may be programmed to send an alert to the remote device if the nitrogen concentration and/or the VFA concentration in the or each first and/or second digestion chambers exceeds a critical threshold value, and/or if the volume of material in the or each tank and/or the first and/or second digestion chambers exceeds a critical value.

The apparatus may comprise one or more gas sensors (e.g. one or more methane sensors) configured to detect (e.g. measure the concentration of) one or more gases (e.g. methane) outside the apparatus. The controller is typically configured to receive one or more outputs from the one or more gas sensors.

The apparatus may comprise an external housing. The external housing may be configured (e.g. shaped and dimensioned) to house (i.e. retain) the or each tank and/or the or each (e.g. two-stage) digester. The external housing may be further configured to retain the controller, the gas purifier (e.g. biogas purifier), the gas storage chamber, the GC, the or each VOC collection container and/or the generator. The wastewater inlet may extend through an external wall of the external housing.

The apparatus may be plumbed into the mains water supply. The apparatus may be electrically connected to the mains electricity supply. The apparatus may be connected to the mains gas supply.

The apparatus may comprise one or more anaerobic microorganisms (e.g. acetobacterium woodii (as deposited at the Leibniz-Institut DSMZ-Deutsche Sammlung von Mikroorganismen und Zellkulturen GmbH under deposit number DSM 1030 and at the American Type Culture Collection under deposit number ATCC 29683) and/or methanosaeta concilii (as deposited at the Leibniz-Institut DSMZ-Deutsche Sammlung von Mikroorganismen und Zellkulturen GmbH under deposit number DSM 3671 and at the American Type Culture Collection under deposit number ATCC 35969)). Typically, the anaerobic digestion comprises the use of microorganisms and the anaerobic digester comprises (e.g. contains) microorganisms. Typically, where the method comprises two-stage anaerobic digestion, the first stage comprises acidogenesis and/or acetogenesis and the microorganisms are acidogenic microorganisms (e.g. acidogenic bacteria and/or acidogenic archaea) and/or acetogenic microorganisms (e.g. acetogenic bacteria and/or acetogenic archaea). Typically, the first digestion chamber of the two-stage anaerobic digester (corresponding to the first stage of the two-stage anaerobic digestion) comprises microorganisms that are resistant to temperature variation. Typically, where the method comprises two-stage anaerobic digestion, the second stage comprises methanogenesis and the microorganisms are methanogenic microorganisms (e.g. methanogenic bacteria and/or methanogenic archaea).

Wastewater may comprise greywater and/or black water and/or clean water. Wastewater may comprise any water from any combination of domestic, industrial, commercial or agricultural activities, from surface runoff, from precipitation, from stormwater and/or sewer inflow and/or sewer infiltration.

The method may comprise causing the biogas to leave the anaerobic digester (e.g. the two-stage anaerobic digester) via a bio-gas outlet. The method may comprise collecting and optionally storing the biogas. The method may comprise causing the biogas to enter a combined heat and power system (or, for example a heat system, or a power system not combined with a heat system) to thereby generate heat and/or power. The method may comprise the use of the resulting heat and/or power to (at least partially) power the apparatus and the method. The method may comprise the use of the resulting power to provide energy to the grid. The method may comprise supplying the purified biogas to the gas grid.

The biogas may further comprise carbon dioxide and/or hydrogen sulphide and/or water vapour and/or siloxanes (e.g. in addition to methane). Typically, the method further comprises causing the biogas to be purified (e.g. non-methane gases are removed from the biogas) by the gas purifier or gas purifiers prior to storage and/or use.

In some embodiments a single-stage anaerobic digester may be used in place of or as well as a two-stage anaerobic digester. In some embodiments the (e.g. two-stage) anaerobic digester is a continuous-use (e.g. two-stage) anaerobic digester. In some embodiments the (e.g. two-stage) anaerobic digester is a batch (e.g. two-stage) anaerobic digester. In some embodiments the (e.g. two-stage) anaerobic digester is a pseudo-continuous batch (e.g. two-stage) anaerobic digester.

In an alternative embodiment of the method, the method may comprise causing thermal hydrolysis to take place within the tank (e.g. the evaporation tank) when sufficient water has evaporated to generate a concentrate comprising at least 8% by weight dry solids, or more preferably at least 10% by weight dry solids. Typically, in this embodiment of the method, thermal hydrolysis comprises closing the tank (e.g. sealing the tank, for example by causing outlet valves to be closed) and subsequently causing a controlled steam explosion within the tank (e.g. the evaporation tank). Typically, in this embodiment of the method, the method comprises increasing the temperature within the tank (e.g. the contents of the tank) to at least 130° C., or more preferably at least 150° C. (e.g. 150° C.±5° C.) and/or substantially maintaining this temperature for between 20 and 40 minutes, or more preferably between 25 and 35 minutes, resulting in thermal hydrolysis of the concentrate. Typically, in this embodiment of the method, the method further comprises the use of a heat exchanger to subsequently cool the contents of the tank, said heat exchanger comprising (e.g. containing) incoming wastewater. Typically, in this embodiment of the method, the method further comprises anaerobic digestion of the (e.g. thermally hydrolysed) concentrate, the anaerobic digestion typically being single-stage anaerobic digestion. Typically, the single-stage anaerobic digestion in this embodiment of the method comprises microbial hydrolysis, acidogenesis, acetogenesis and methanogenesis. Typically, microbial hydrolysis, acidogenesis, acetogenesis and methanogenesis all take place in the same digestion chamber (i.e. as opposed to microbial hydrolysis, acidogenesis and acetogenesis taking place in a first digestion chamber and methanogenesis taking place in a second digestion chamber).

A further aspect of the invention comprises digestate (optionally digestate, sludge and/or soil treatment products such as fertiliser) and/or VOCs obtained as a result of the method and/or through the use of the apparatus as described above.

Features described above in respect of either the first or second aspect of the invention are optional features of both the first and second aspects of the invention.

### DESCRIPTION OF THE DRAWINGS

An example embodiment of the present invention will now be illustrated with reference to the following Figures in which:

FIG. 1 is a diagram of an example embodiment of a wastewater treatment apparatus according to the invention;

FIG. 2 is a diagram of a traditional wastewater treatment facility using the Activated Sludge (AS) system, as is known in the art;

FIG. 3 is a flow chart showing the main stages of one embodiment of the method;

FIG. 4 is a diagram of a combined heat and power generator; and

FIG. 5 is a diagram of an example of equipment for use in the recovery of VOCs using a gas chromatograph (GC).

### DETAILED DESCRIPTION OF AN EXAMPLE EMBODIMENT

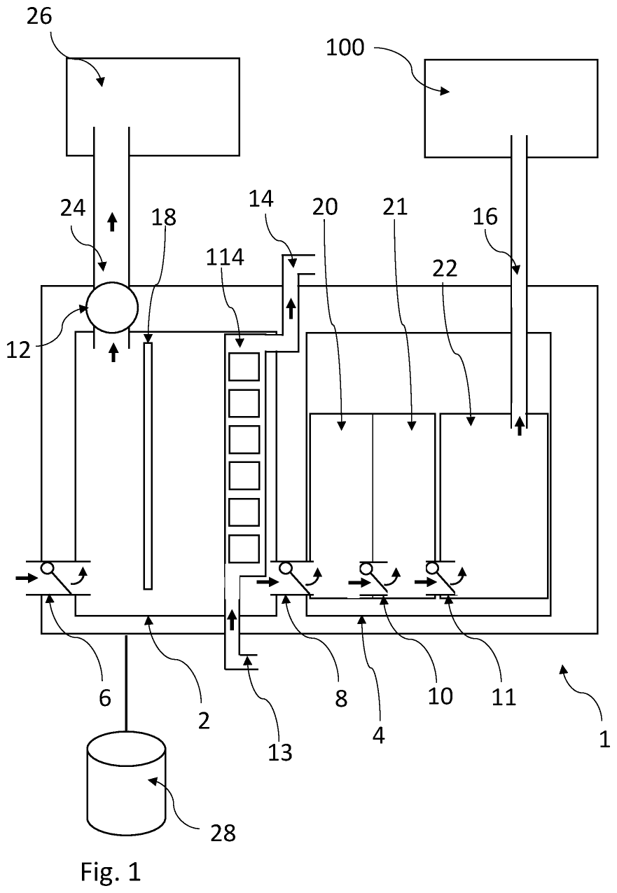

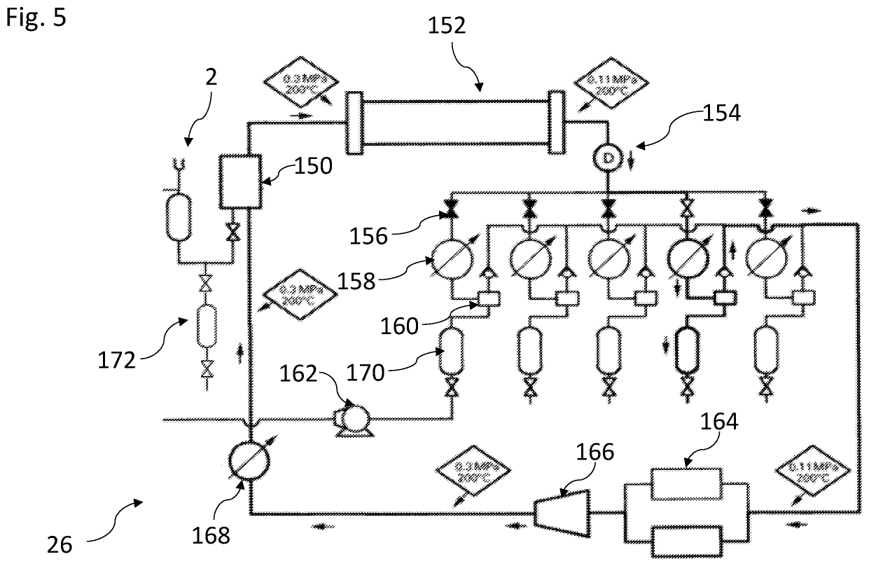

With reference to FIG. 1, in one example embodiment of the invention a wastewater treatment apparatus (1) has a vacuum evaporation tank (2), a two-stage anaerobic digester (4), a wastewater inlet (6), a first conduit (8) through which concentrate can flow, a second conduit (10) through which concentrate can flow from a first digestion chamber (20), into a thermal hydrolysis chamber (21) and a third conduit (11) through which concentrate and/or hydrolysed sludge can flow into a second digestion chamber (22). The vacuum evaporation tank (2) also has a heater (18), and a gas outlet (24) via which VOCs and water vapour can leave the evaporation tank (2). The vacuum evaporation tank also has a vacuum pump (12). Volatile organic compounds (VOCs) that leave the tank (2) via the gas outlet (24) are directed to the gas collector in the form of a gas recovery unit (26). The gas recovery unit (26) includes a gas chromatograph and several VOC collection containers (see FIG. 5). The vacuum evaporation tank (2) also has a heat exchanger (114) with a water vapour inlet (13) and a condensed water outlet (14). In use, hot water vapour enters the heat exchanger via the water vapour inlet, and heat from the hot water vapour increases the temperature of the contents of the evaporation tank (2), thus cooling and condensing the hot water vapour, which can then leave via the condensed water outlet (14) and is discharged to the mains water supply or to a river. The two-stage anaerobic digester also has an outlet (16) through which biogas is supplied to a gas purifier, and subsequently to a gas collection chamber and finally to a cogenerator (100). The cogenerator (100) is used to supply energy both to the apparatus and to the grid. The apparatus (1) also has a controller (28).

While in the example illustrated in FIG. 1, only one vacuum evaporation tank (2) is shown, typically more than one vacuum evaporation tank (2) would be provided and each vacuum evaporation tank (2) would be supplied with wastewater for treatment. In which case, the wastewater would be treated in a batch process. In some embodiments of the invention the wastewater would be treated in a semi-continuous batch process.

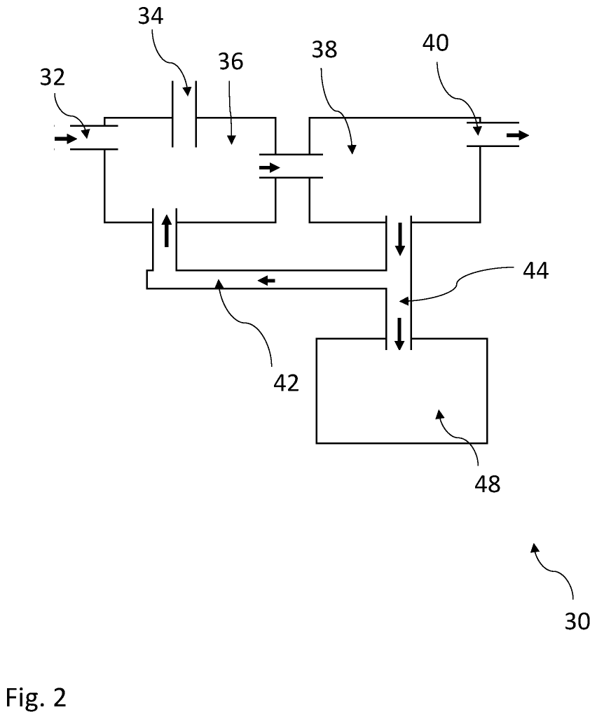

This is in contrast to a traditional wastewater treatment facility (30) using the Activated Sludge (AS) process as indicated in the diagram of FIG. 2. Such facilities (30) typically have an initial primary sedimentation tank where the outflow from preliminary treatment (including flow measurement, screening, comminution, and grit removal) is allowed to settle under gravity (thereby generating a primary sludge) and the effluent is passed on for secondary treatment using the AS process. The generated primary sludge is usually transferred to a thickener (e.g. a picket fence thickener) and is thereby thickened such that is has a 5-6% dry solid concentration.

The secondary stage of a traditional wastewater treatment facility (using the AS process, as is known in the art) has a water inlet (32) and an air inlet (34) which allow water and air, respectively, to enter an aeration tank (36). Sludge and wastewater (AS) move to a clarifying-settling tank (38) where the AS is allowed to settle (thereby generating a secondary sludge), leaving behind clear water which can then leave (40) the clarifying-settling tank (38) for further treatment (e.g. UV treatment) before being returned to the mains water supply. Part of the settled secondary sludge is recycled (42) and returned to the aeration tank (36) and part of the settled secondary sludge leaves the clarifying-settling tank (44), is further thickened using a centrifuge belt (to enhance settling) such that it has a 5-6% dry solid concentration and is then mixed with primary sludge in a sludge holding tank at a proportion dependent on the design of downstream sludge processing to be treated (in this example) by an anaerobic digester (48) (which leads to the production of biogas). Such treatment processes sometimes also include thermal hydrolysis of the sludge (not shown here) before the sludge is further processed.

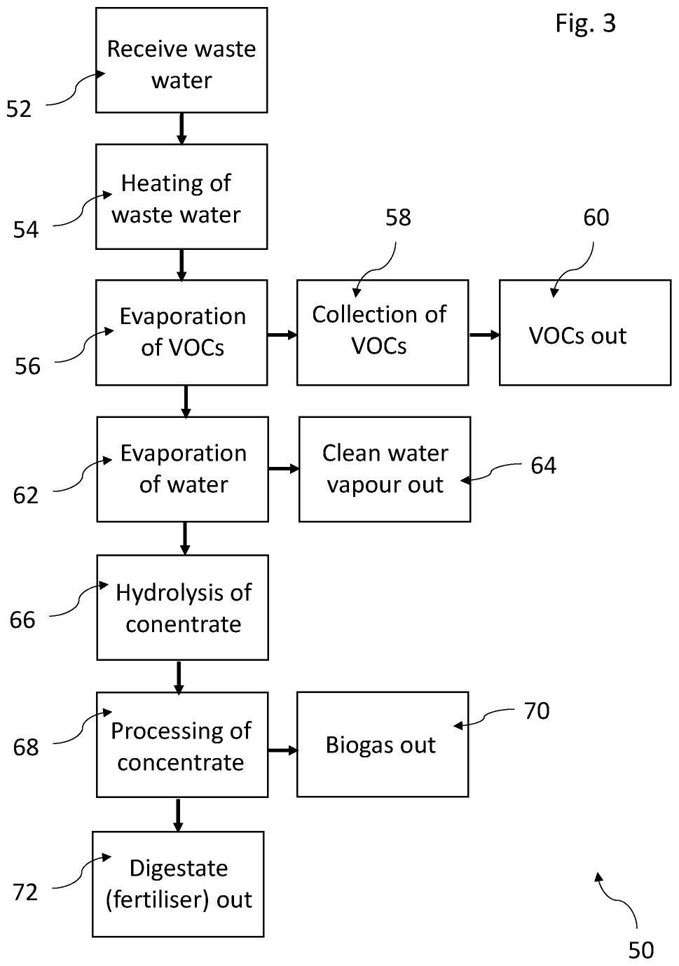

FIG. 3 is a flow chart of the main steps of one example of the method (50). In this example embodiment of the invention, the method (50) begins when wastewater is received (52) in the apparatus (1) and thereby into the vacuum evaporation tank (2). The vacuum pump (12) and heater (18) are switched on to adjust the conditions in the tank (2), i.e. the pressure is reduced to 20 kPa, (reducing the boiling point of the VOCs and the water), and the wastewater is gradually heated (54). This causes the VOCs in the wastewater to start to evaporate (56) (note that each distinct individual compound of the VOCs will evaporate at a different temperature and pressure). The VOCs leave the tank (2) via the gas outlet (24) of the vacuum evaporation tank (2) and are collected (58) (in the example embodiment of the invention illustrated in FIG. 1, the VOCs would be supplied to the gas recovery unit (26)). The VOCs can then leave (60) the apparatus (1). At ˜60° C. the water also starts to evaporate (62). The water vapour is collected, compressed (thereby increasing its temperature) and recycled for use at various stages of the method (50), e.g. for providing heat for thermal hydrolysis and/or to subsequent batches of incoming wastewater in the vacuum evaporation tank or tanks. The water vapour is then condensed and allowed to leave (64) the tank (2) via the water outlet (14) and can then be returned to the mains water supply or discharged to a river or nearby body of water.

By removing the VOCs and a portion of the water vapour a concentrate is produced. The next step of the method (50) involves processing (68) of the concentrate, in this example by anaerobic digestion. In this example, the anaerobic digestion takes place in two stages (i.e. it is two-stage anaerobic digestion) however, it will be appreciated that a single anaerobic digestion stage may alternatively be used. The first stage of anaerobic digestion involves microbial hydrolysis, acidogenesis and acetogenesis of the concentrate. The concentrate is then thermally hydrolysed. Thermal hydrolysis of the concentrate at this point allows any cellular material (e.g. from the microbial hydrolysis, acidogenesis and acetogenesis, as well as long chain fatty acids) to be broken down, thereby generating a sludge. Thermal hydrolysis ensures that the sludge is more soluble than it would be without the inclusion of the thermal hydrolysis step.

The sludge then undergoes the second stage of anaerobic digestion. The second stage of anaerobic digestion involves methanogenesis (the sludge is suitable for being readily taken up by methanogenic archaea as a result of the preceding thermal hydrolysis, the thermal hydrolysis also having reduced the potential for microbial competition and the frequent system perturbations that are common to methanogenic archaea). During the second stage of anaerobic digestion, the conditions within the second digestion chamber are controlled in response to measurements recorded by sensors which monitor the quality and quantity of sludge received from the thermal hydrolysis tank (including the acid concentration) and the accumulation of volatile fatty acids (VFAs) is thereby limited.

The anaerobic digestion produces biogas which leaves (70) the anaerobic digester (4) via the outlet (in the example embodiment of the invention illustrated in FIG. 1 the biogas would then be supplied to the cogenerator (100) where it would be combusted in order to supply energy to the apparatus). The anaerobic digestion also produces digestate (i.e. sludge). When the anaerobic digestion is complete the digestate (i.e. sludge) is removed (72) from the anaerobic digester.

This process leads to high degradation of the biodegradable substances fed into the anaerobic digester, resulting in a high volume of biogas being produced and a low volume of sludge being produced. The resultant digestate is suitable for use as a soil enhancer (as it is free from contaminants including VOCs and compounds that are produced during aerobic digestion) and can be applied directly to soil (e.g. as a fertiliser) or dried and stored for future use.

Note that in the example embodiment of the invention illustrated in FIG. 3, evaporation of wastewater and VOCs and collection of VOCs occur sequentially. In other example embodiments they may occur in a different order or simultaneously. In some example embodiments of the invention the method illustrated in FIG. 3 is carried out in several tanks (2) simultaneously, in which case each step of the method may be carried out in each tank (2) at the same time as it is carried out in each other tank (2), however it is more likely that each step of the method will be carried out in each tank (2) asynchronously.

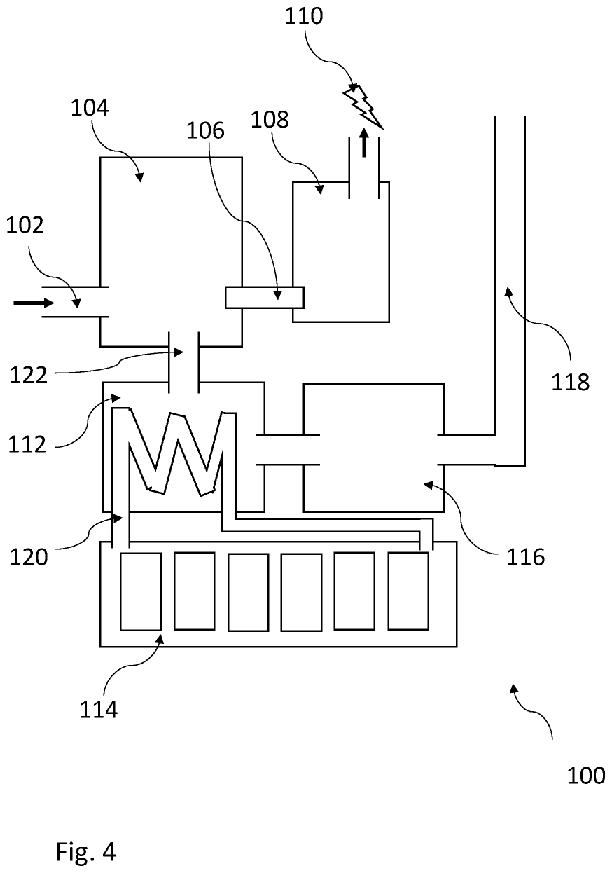

FIG. 4 is a diagram of a cogenerator (a combined heat and power (CHP) generator) (100). The cogenerator has an inlet (102) through which biogas is supplied. The inlet (102) leads to a combustion engine (104) where the biogas is combusted. The combustion engine (104) is connected to an electricity generator (108) driven by the drive shaft (106) of the combustion engine (104). The exhaust heat from the combustion engine (104) is supplied to a heat exchanger (112). Cold water (120) is supplied to the heat exchanger (112) and picks up heat from the exhaust gas (122) that results from combustion of the biogas. The water (120) leaves the heat exchanger (112) at a higher temperature and (in this example) is supplied directly to a radiator (114), although it should be understood that it may instead be supplied to a central heating system, for example. The exhaust gas (122) is supplied to a catalytic converter (116) which removes some compounds from the exhaust gas. The exhaust gas then leaves the cogenerator via the exhaust pipe (118).

Referring to FIG. 5, the GC is connected to the vacuum evaporation tank (2) and a water vapour outlet (172). The GC has a gas injector (150) where the gases are periodically mixed with the carrier gas before they are injected into the gas column (152). The gas column (152) is made of stainless steel and is packed with the stationary phase (one skilled in the art will appreciate that the gas chromatograph may have multiple columns and that the choice of stationary phase and carrier gas will depend on the target VOCs.) The gas column (152) is heated by fluid circulating in a jacket around the column (152) to maintain the carrier gas and the injected VOCs at a constant temperature. The GC also has a thermal conductivity detector (154), several selection valves (156) that allow selected VOCs to collect in several VOC condensers (158), several gas-liquid separators (160) and a pump (162) arranged such that individual, distinct VOCs may be removed from the GC. The GC also has a carrier gas cleaner (164), a carrier gas compressor (166) and a carrier gas heater (168). In use, the retention time of target analytes (e.g. individual, distinct VOCs) would be pre-programmed into the controller (28) and these analytes (VOCs) are detected by the detector (154) as they elute from the column (152). In response to the detection of a given analyte (VOC), the controller causes a selection valve (156) to open (note that only one valve (156) is open at any given time). Subsequent cooling of the mixture of carrier gas and vaporised analyte (VOC) result in the vaporised analyte condensing out of the carrier gas. The carrier gas is then physically separated from the condensed (liquefied) sample by the gas-liquid separators (160) and is recycled while the recovered analyte (VOC) is directed to an appropriate VOC collection container (170).

Any traces of VOCs are removed from the carrier gas by the carrier gas cleaner (164) (the carrier gas cleaner in this example is an activated charcoal bed). Then the carrier gas is compressed by the carrier gas compressor (166) and is heated by the carrier gas system (in this example to ˜80° C.).

1. A method for treating wastewater, the method comprising receiving wastewater into a tank via a wastewater inlet, heating the received wastewater in the tank, thereby evaporating water and evaporating volatile organic compounds (VOCs) out of the wastewater, and thereby forming a concentrate, the method further comprising collecting the evaporated VOCs and processing the concentrate, said processing comprising anaerobic digestion.

2. The method according to claim 1 further comprising heating and/or thermal hydrolysis of the wastewater and/or the concentrate and/or sludge.

3. The method according to claim 1 wherein the evaporation comprises vacuum evaporation.

4. The method according to claim 1 wherein vacuum evaporation comprises generating water vapour and the method comprises causing heat exchange from the water vapour to subsequent influent batches of wastewater received into the tank.

5. The method according to claim 1 wherein the anaerobic digestion comprises the production of biogas, optionally biogas comprising at least 50% methane, and/or collection of the biogas.

6. The method according claim 5 wherein the method further comprises combustion of the biogas in a cogenerator, thereby producing energy and optionally using the energy generated to provide power for the method.

7. The method according to claim 1 wherein the anaerobic digestion is two-stage anaerobic digestion, comprising a first stage and a second stage, the first stage comprising hydrolysis of the concentrate and/or acidogenesis and/or acetogenesis and the second stage comprising methanogenesis.

8. The method according to claim 7 wherein the method further comprises a thermal hydrolysis step carried out on organic matter after the first stage and before the second stage.

9. The method according to claim 1 wherein the method further comprises causing the VOCs to be captured by a gas collector and/or supplied to a gas chromatograph (GC) and optionally thereby separated into distinct, individual compounds.

10. The method according to claim 1 wherein the method further comprises regulating the flow of received wastewater.

11. An apparatus for treating wastewater, the apparatus comprising a wastewater inlet, a controller, a gas collector, an anaerobic digester, at least one heating means at least one tank and at least one vacuum pump, the at least one tank comprising at least one tank inlet and at least one tank outlet; wherein the heating means and/or the vacuum pump are configured to cause evaporation of the contents of the tank, the gas collector being configured to collect volatile organic compounds, where present, thereby evaporated from the contents of the tank.

12. The apparatus according to claim 11 further comprising a generator, optionally a cogenerator.

13. The apparatus according to claim 11 wherein the gas collector comprises a gas chromatograph (GC) and/or a plurality of VOC collection containers.

14. The apparatus according to claim 11 wherein the apparatus further comprises a conduit through which wastewater and/or concentrate may flow into the anaerobic digester.

15. The apparatus according to claim 11 wherein the apparatus further comprises flow regulation means, the flow regulation means optionally comprising a pump.

16. The apparatus according to claim 11 wherein the anaerobic digester is a two-stage anaerobic digester, the two-stage anaerobic digester comprising a first digestion chamber and second digestion chamber at least partially separated from the first digestion chamber.

17. The apparatus according to claim 16 wherein the anaerobic digester further comprises a thermal hydrolysis chamber.

18. The apparatus according to claim 11 wherein the apparatus further comprises a plurality of sensors, the or each sensor comprising one or more pH sensors, flow meters, temperature sensors, pressure sensors and/or nitrogen sensors.

19. The apparatus according to claim 13 wherein the GC comprises a large scale preparative GC, the GC further comprising a GC-inlet, a GC outlet and a column, the column comprising a stationary phase and a carrier gas.

20. The apparatus according to claim 11 wherein the apparatus further comprises one or more gas purifiers.

21. The apparatus according to claim 11 wherein the apparatus further comprises one or more gas sensors configured to detect one or more gases outside the apparatus.

22. The apparatus according to claim 11 wherein the apparatus further comprises comprise an external housing, the external housing configured to retain the or each tank, digester, controller, gas purifier, gas storage chamber, GC, VOC collection container, and/or generator, wherein the wastewater inlet extends through an external wall of the external housing.

23. The apparatus according to claim 11 wherein the apparatus is plumbed into the mains water supply and/or is electrically connected to the mains electricity supply and/or is connected to the mains gas supply.

24. The apparatus according to claim 11 wherein the apparatus further comprises one or more anaerobic microorganisms.

25. Digestate and/or VOCs obtained as a result of the method according to claim 1 and/or through the use of the apparatus.
